(19) United States
(12) Patent Application Publication
(10) Pub. No.: US 2025/0362422 A1
(43) Pub. Date: Nov. 27, 2025

(54) OPTIMIZATION OF SHALLOW VELOCITY IMAGING USING SUPER-VIRTUAL INTERFEROMETRY AND WAVE-EQUATION TRAVEL-TIME INVERSION

(71) Applicant: SAUDI ARABIAN OIL COMPANY, Dhahran (SA)

(72) Inventors: Nouf ALSAAD, Dhahran (SA); Ali ALDAWOOD, Dhahran (SA)

(73) Assignee: SAUDI ARABIAN OIL COMPANY, Dhahran (SA)

(21) Appl. No.: 18/669,754

(22) Filed: May 21, 2024

(51) Int. Cl. G01V 1/30; G01V 1/28

(52) U.S. Cl. CPC G01V 1/303; G01V 1/282

(57) ABSTRACT

A computer-implemented method and system for optimizing shallow subsurface imaging includes applying super-virtual interferometric redatuming (SVIR) to seismic wave data, and applying wave-equation travel-time inversion (WTI) to the redatumed seismic wave data.

### FIELD OF THE DISCLOSURE

The present disclosure relates generally to shallow subsurface imaging, and more particularly, to optimizing shallow subsurface imaging by applying super-virtual interferometric redatuming and wave-equation travel-time inversion in accordance with certain embodiments.

### BACKGROUND OF THE DISCLOSURE

The quality of seismic data in complex shallow subsurface geology suffers from weak signals caused by near-surface-generated noise, resulting in highly jittery arrivals. This leads to difficulty in reading and processing seismic data that introduces significant uncertainties especially at far-offset receivers at which the signal-to-noise ratio drops and it becomes difficult to pick first-arrival travel-times.

Conventional subsurface imaging techniques such as refraction tomography are effective methods to solve for near surface issues; however, there are some limitations to using these conventional approaches. For example, small-scale features may not be detected due to the low resolution and accuracy of first-break travel-time tomographic inversion/imaging. Another challenge is noise interference with seismic signals, especially at far offset. Commonly, the direct-wave and first refractors are visible in shot records, the second refractor is weak and hidden below the noise level as shown in the schematic of FIG. 1. In addition, there may be acquisition challenges whereby access may be difficult to conduct surveys with finely spaced receivers.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a computer-implemented method for optimizing shallow subsurface imaging includes applying super-virtual interferometric redatuming (SVIR) to seismic wave data, and applying wave-equation travel-time inversion (WTI) to the redatumed seismic wave data.

In another embodiment, a machine-readable storage medium having stored thereon a computer program for optimizing shallow subsurface imaging. The computer program includes a routine of set instructions for causing the machine to perform the steps of applying super-virtual interferometric redatuming (SVIR) to seismic wave data, and applying wave-equation travel-time inversion (WTI) to the redatumed seismic wave data.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is schematic diagram showing enhancement of the far offset refraction arrivals using SVIR, enabling the picking of the deeper refractors.

FIG. 2 is a schematic diagram showing that the new redatumed source to receiver refracted arrival path (from r₁ to the virtual shot) will be a result of the cross-correlation of the refracted arrivals of r₁ and r₂.

FIG. 3 is a schematic diagram showing that the convolution of the refracted arrival paths from the source to r₁ and the virtual shot to r₂ will eliminate the negative time resultant and redatum the source back to the surface.

FIG. 4 is a flow diagram of a method for optimizing shallow subsurface imaging by merging of two approaches, super-virtual interferometric redatuming (SVIR) and wave-equation travel-time inversion (WTI), in accordance with certain embodiments.

FIG. 5 is a block diagram of a system for optimizing shallow subsurface imaging by applying super-virtual interferometric redatuming and wave-equation travel-time inversion in accordance with certain embodiments.

FIG. 6 is a block diagram of a computer system that may be used to implement one or more of the systems or methods described herein in accordance with certain embodiments.

FIG. 7 depicts a cloud computing environment that can be used to perform one or more actions according to an aspect of the present disclosure.

### DETAILED DESCRIPTION

Embodiments of the present disclosure will now be described in detail with reference to the accompanying drawing figures. Like elements in the various figures may be denoted by like reference numerals. Further, in the following detailed description, specific details are set forth in order to provide a more thorough understanding of the claimed subject matter. However, it will be apparent to one of ordinary skill in the art that the embodiments disclosed herein may be practiced without these specific details, or with details that are not described herein in the interest of clarity. Thus in some instances, well-known features have not been described in detail to avoid unnecessarily complicating the description. Additionally, it will be apparent to one of ordinary skill in the art that the scale of the elements presented in the accompanying drawing figures may vary without departing from the scope of the present disclosure.

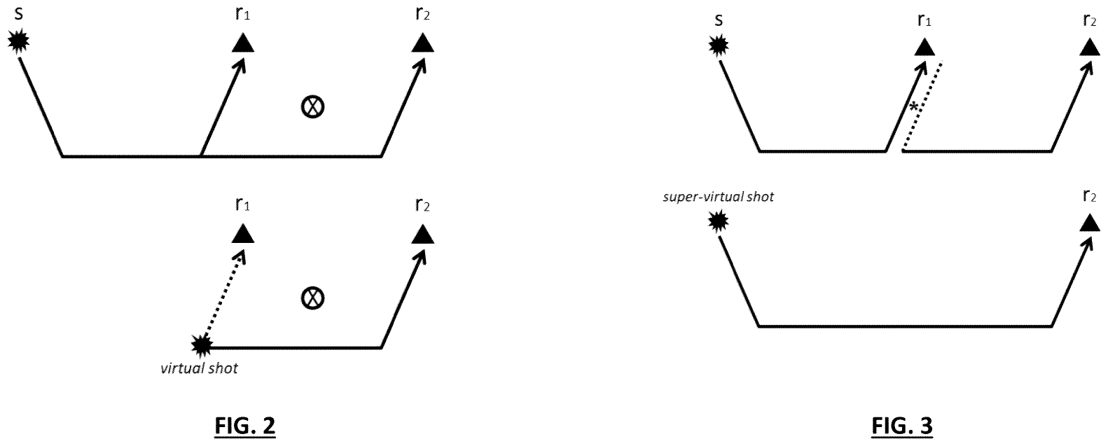

Embodiments in accordance with the present disclosure generally relate to optimizing shallow subsurface imaging by applying super-virtual interferometric redatuming and wave-equation travel-time inversion. Interferometric redatuming is an effective method to address the noisy recorded wavefields in refraction surveys and characterize geological features in seismic imaging. It improves the signal-to-noise ratio (SNR) of the refraction wavefield by transforming the response of the wavefield to a different datum, which is done through a cross-correlation redautming process as shown in FIG. 2. In addition, the virtual source method can create super-grouped (i.e., summed) sources and place them at far offset receiver locations to enhance the refracted signals and attenuate noise. Overall, this method expands the picked offset range of the data and improves the quality of first break picks at far offsets for building robust velocity profiles. The cross-correlation redatuming in the frequency domain can be written as follows:

$${G}^{v} ( {r}_{2} , {r}_{1} ) = {\sum }_{s} G ( {r}_{2} , s ) {G}^{*} ( {r}_{1} , s ) , \qquad Equation ( 1 )$$

As seen in FIG. 2, the new redatumed source to receiver refracted arrival path (from r₁ to the virtual shot) will be a result of the cross correlation of the refracted arrivals of r₁ and r₂.

In accordance with certain embodiments, and with reference to FIG. 3, super-virtual interferometric redatuming is performed, whereby the virtual source from the subsurface location on the refractor is redatumed with its negative excitation time, denoted by the dashed arrow in FIG. 2, back to the original position on the surface. To do so, the redatmued virtual source G^{v}(r₂,r₁) and original trace with the correct arrival path G(r₁,s) are convolved. As a result, the new redatumed summation of the super-virtual source G^{sv}(r₂,s) is obtained as shown in Equation (2):

$${G}^{s v} ( {r}_{2} , s ) = {\sum }_{{r}_{1}} {G}^{v} ( {r}_{2} , {r}_{1} ) G ( {r}_{1} , s ) , \qquad Equation ( 2 )$$

FIG. 3 shows that the convolution of the refracted arrival paths from the source to r₁ and the virtual shot to r₂ eliminate the negative time resultant and redatum the source back to the surface.

Further in accordance with certain embodiments, wave-equation travel-time inversion (WTI) can be performed. WTI is an iterative scheme, which provides a unique solution to reconstruct high resolution velocity models. This technique works by using travel-times and the Frechet derivative of the wave-equation. It is an effective method to minimize travel-time residuals, detect small-scale velocity features, and image with higher-resolution capability than conventional travel-time tomography the near-surface complexities, and is described with reference to Equation (3):

$${f}_{Δ τ} = \int d t \frac{p ( {x}_{r} , t + Δτ ; {x}_{s} )}{{A}_{d} ( {x}_{r} ; {x}_{s} )} p ( {x}_{r} , t ; {x}_{s} ) , \qquad Equation ( 3 )$$

The cross correlation function (f_{Δτ}) is a result of connecting the travel-times and pressure seismograms, where A_{d}(xᵣ; xₛ) is the maximum amplitude of p(xᵣ, t+Δτ; xₛ), Δτ is the travel-times residual between the synthetic and original seismograms to compute for the Frechet derivative.

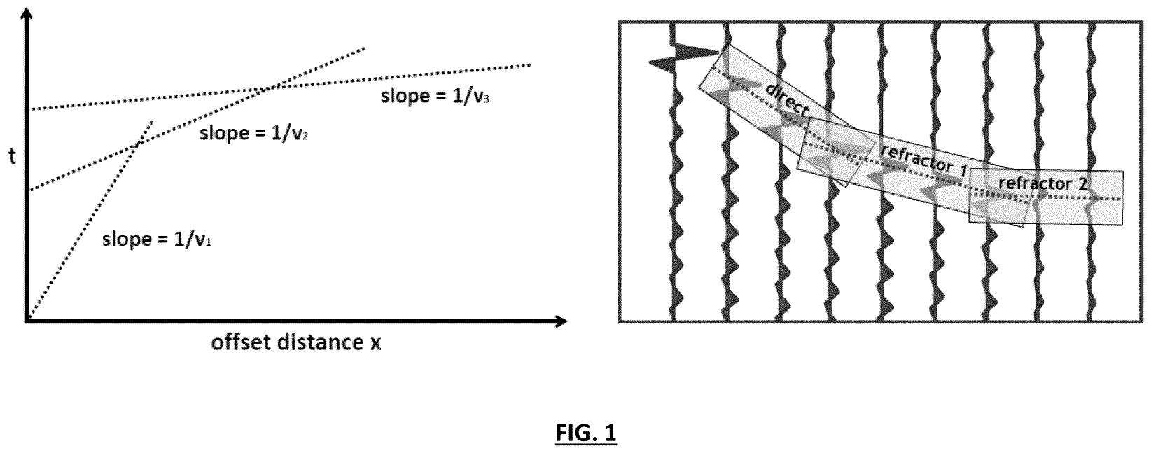

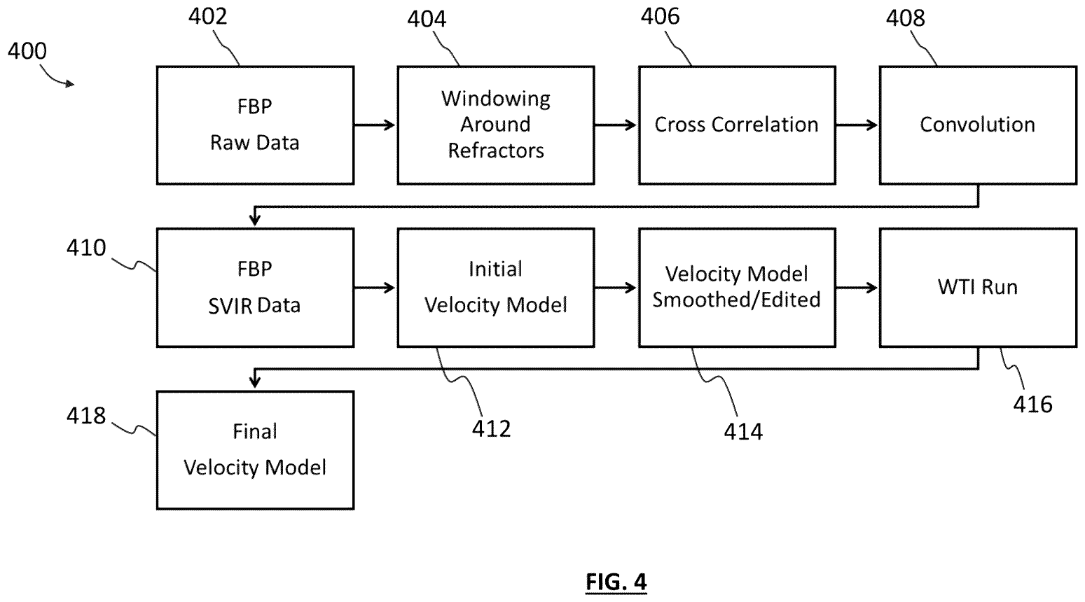

FIG. 4 is a flow diagram of a method 400 for optimizing shallow subsurface imaging by merging of two approaches, super-virtual interferometric redatuming (SVIR) and wave-equation travel-time inversion (WTI), in accordance with certain embodiments. The method begins at 402 at selection of first break picks raw data for performance of super-virtual interferometric redatuming (SVIR). This involves picking first break arrival times on the raw waveform. The picked travel time can be on the peak, trough, zero-crossing of the first arriving waveform. (For reference, FIG. 1, right-hand side, shows 9 traces with 9 different waveforms with arrivals that come later as a function of distance.) At 404, windowing around refractors is performed, and can involve designing a mute function around the first arriving waveforms with the aid of the picks on 402. Thus, a window of 10-30 ms centered around the first-arriving waveform can be applied to the data to extract the desired refraction energy as a priority to apply super-virtual interferometric redatuming. At 406, cross-correlation is performed, as explained above in connection with Equation (1) and FIG. 2, to transform the response of the wavefield to a different datum, with super-grouped sources being created and placed at far offset receiver locations to enhance the refracted signals and attenuate noise. Overall, this approach expands the picked offset range of the data and improves the quality of first break picks at far offsets for building robust velocity profiles. At 408, the redatmued virtual source G^{v}(r₂,r₁) and original trace with the correct arrival path G(r₁,s) are convolved. This redatums the virtual source from the subsurface location on the refractor with its negative excitation time back to the original position on the surface, bringing back the data to the original acquisition geometry as shown in FIG. 3. An aim of this is to obtain less jittery and robust virtual source gathers (virtual common source gathers) at far offset receivers and enhance the overall signal-to-noise (SNR) quality of the refracted seismic data.

At 410, the first break picks from the super-virtual interferometric redatuming are selected for application of wave-equation travel-time inversion (WTI) in order to improve the wavelet response, which may have been compromised in the cross-correlation and convolution processes of interferometric summations above. WTI will require two inputs: first break picks from the newly picked arrivals, and an improved initial velocity model from the reconstructed virtual gathers, at 412. To capture high quality picks and velocity inversions, the near offset picks must be preserved from the original seismic data, and the far receivers should be re-picked from the newly reconstructed data. At 414, smoothing and editing of the velocity model may be applied, and at 416, the WTI process is executed to achieve the final velocity model at 418.

While for purposes of simplicity of explanation, the example method of FIG. 4 is shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods, and conversely, some actions may be performed that are omitted from the description.

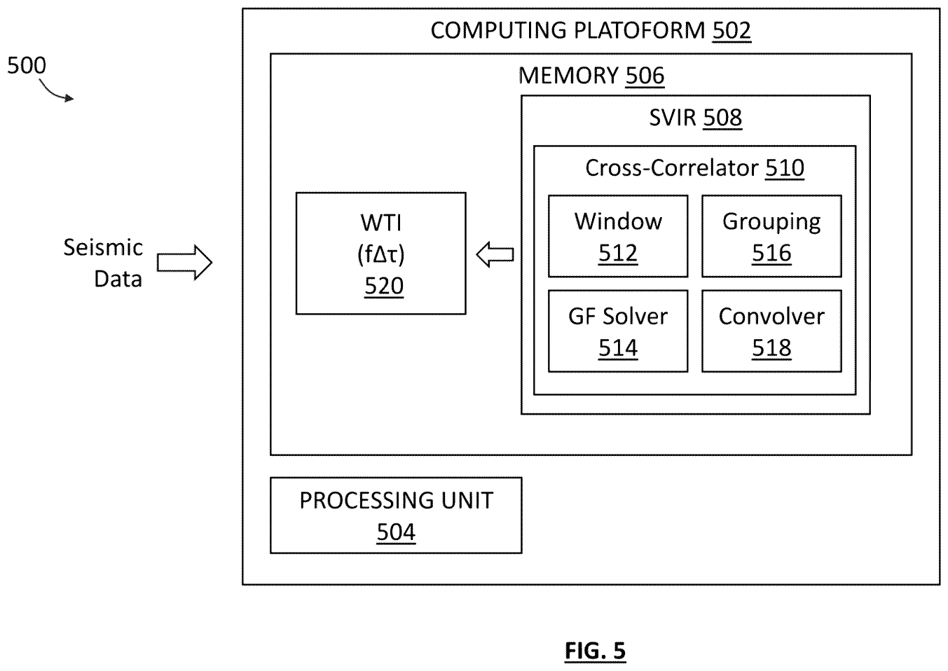

FIG. 5 is an example of a block diagram of a system 500 for optimizing shallow subsurface imaging by applying super-virtual interferometric redatuming and wave-equation travel-time inversion in accordance with certain embodiments. The system 500 can be implemented using one or more modules, shown in block form in the drawings. The one or more modules can be in software or hardware form, or a combination thereof. In some examples, the system or portions thereof can be implemented as machine readable instructions for execution on one or more computing platforms 502 (referred to as a computing platform herein), as shown in FIG. 5. The computing platform 502 can include one or more computing devices selected from, for example, a desktop computer, a server, a controller, a blade, a mobile phone, a tablet, a laptop, a personal digital assistant (PDA), and the like.

The computing platform 502 can include a processing unit 504 and a memory 506. By way of example, the memory 506 can be implemented, for example, as a non-transitory computer storage medium, such as volatile memory (e.g., random access memory), non-volatile memory (e.g., a hard disk drive, a solid-state drive, a flash memory, or the like), or a combination thereof. The processing unit 504 can be implemented, for example, as one or more processor cores. The memory 506 can store machine-readable instructions that can be retrieved and executed by the processing unit 504 to implement optimization of shallow subsurface imaging by applying super-virtual interferometric redatuming and wave-equation travel-time inversion as described herein. Each of the processing unit 504 and the memory 506 can be implemented on a similar or a different computing platform. The computing platform 502 can be implemented in a cloud computing environment (for example, as disclosed herein) and thus on a cloud infrastructure. In such a situation, features of the computing platform 502 can be representative of a single instance of hardware or multiple instances of hardware executing across the multiple of instances (e.g., distributed) of hardware (e.g., computers, routers, memory, processors, or a combination thereof). Alternatively, the computing platform 502 can be implemented on a single dedicated server or workstation.

System 500 includes SVIR module 508 having a cross-correlator module 510 in which a windowing module 512 is configured to select time windows for a Green's function solver 514 from first break picks raw data received by system 500. SVIR 508 also includes grouping module 516 for summing sources and shifting them to far offset receiver locations to enhance the refracted signals and attenuate noise, expanding the picked offset range of the data and improving the quality of first break picks at far offsets for building robust velocity profiles. In addition, a convolver 518 is provided to convolve the redatmued virtual source G^{v}(r₂,r₁) and original trace with the correct arrival path G(r₁,s) as described above and in accordance with Equation (2) and illustrated in FIG. 3.

System 500 also includes WTI module 520 configured to perform an iterative process for constructing the high-resolution velocity models. It implements the cross correlation function (f_{Δτ}) (Equation (3) above) which is a result of connecting the travel-times and pressure seismograms, where A_{d}(xᵣ; xₛ) is the maximum amplitude of p(x, t+Δτ; xₛ), Δτ is the travel-times residual between the synthetic and original seismograms to compute for the Frechet derivative.

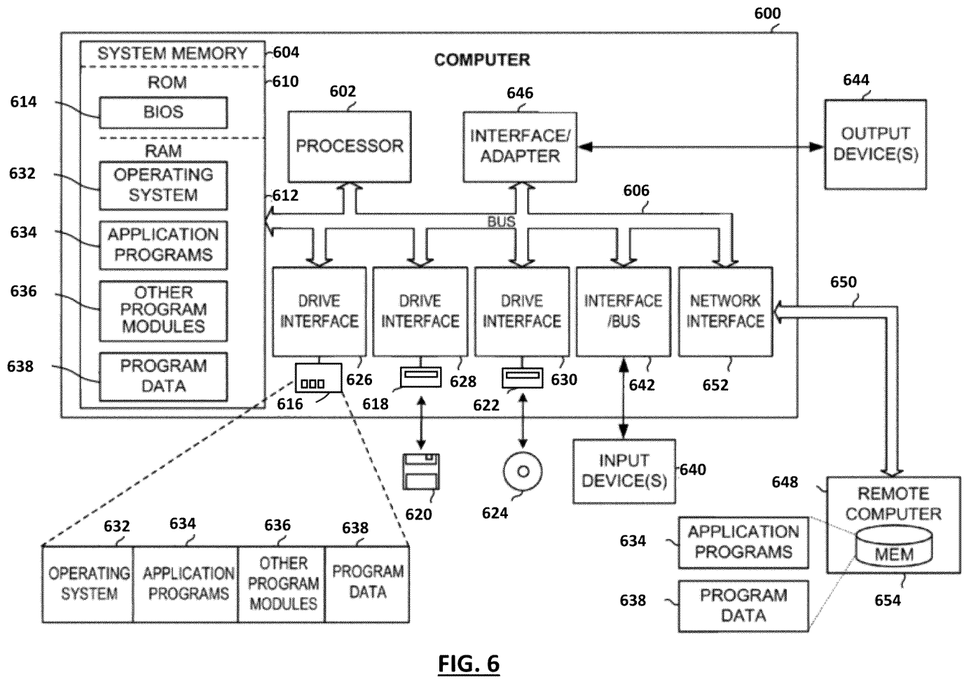

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 6. Furthermore, portions of the embodiments may be a computer program product on a computer-readable storage medium having computer readable program code on the medium. Any non-transitory, tangible storage media possessing structure may be utilized including, but not limited to, static and dynamic storage devices, volatile and non-volatile memories, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, as appropriate.

Certain embodiments have also been described herein with reference to block illustrations of methods, systems, and computer program products. It will be understood that blocks and/or combinations of blocks in the illustrations, as well as methods or steps or acts or processes described herein, can be implemented by a computer program comprising a routine of set instructions stored in a machine-readable storage medium as described herein. These instructions may be provided to one or more processors of a general purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions may also be stored in computer-readable memory that can direct a computer or other programmable data processing apparatus to function in a particular manner, such that the instructions stored in the computer-readable memory result in an article of manufacture including instructions which implement the function specified. The computer program instructions may also be loaded onto a computer or other programmable data processing apparatus to cause a series of operational steps to be performed on the computer or other programmable apparatus to realize a computer implemented process such that the instructions which execute on the computer or other programmable apparatus provide steps for implementing the functions specified in flowchart blocks that may be described herein.

In this regard, FIG. 6 illustrates one example of a computer system 600 that can be employed to execute one or more embodiments of the present disclosure. Computer system 600 can be implemented on one or more general purpose networked computer systems, embedded computer systems, routers, switches, server devices, client devices, various intermediate devices/nodes or standalone computer systems. Additionally, computer system 600 can be implemented on various mobile clients such as, for example, a personal digital assistant (PDA), laptop computer, pager, and the like, provided it includes sufficient processing capabilities.

Computer system 600 includes processing unit 602, system memory 604, and system bus 606 that couples various system components, including the system memory 604, to processing unit 602. System memory 604 can include volatile (e.g. RAM, DRAM, SDRAM, Double Data Rate (DDR) RAM, etc.) and non-volatile (e.g. Flash, NAND, etc.) memory. Dual microprocessors and other multi-processor architectures also can be used as processing unit 602. System bus 606 may be any of several types of bus structure including a memory bus or memory controller, a peripheral bus, and a local bus using any of a variety of bus architectures. System memory 604 includes read only memory (ROM) 610 and random access memory (RAM) 612. A basic input/output system (BIOS) 614 can reside in ROM 610 containing the basic routines that help to transfer information among elements within computer system 600.

Computer system 600 can include a hard disk drive 616, magnetic disk drive 618, e.g., to read from or write to removable disk 620, and an optical disk drive 622, e.g., for reading CD-ROM disk 624 or to read from or write to other optical media. Hard disk drive 616, magnetic disk drive 618, and optical disk drive 622 are connected to system bus 606 by a hard disk drive interface 626, a magnetic disk drive interface 628, and an optical drive interface 630, respectively. The drives and associated computer-readable media provide nonvolatile storage of data, data structures, and computer-executable instructions for computer system 600. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and RAM 610, including operating system 632, one or more application programs 634, other program modules 636, and program data 638. In some examples, the application programs 634 can include one or more of SVIR 508 or WTI 520, and/or cross-correlator 510, windower 512, GF solver 514, grouper 516, or convolver 518 for example, and the program data 638 can include any of the seismic data acquired and or generated. The application programs 634 and program data 638 can include functions and methods programmed to optimize shallow subsurface imaging by applying super-virtual interferometric redatuming and wave-equation travel-time inversion, such as shown and described herein.

A user may enter commands and information into computer system 600 through one or more input devices 640, such as a pointing device (e.g., a mouse, touch screen), keyboard, microphone, joystick, game pad, scanner, and the like. These and other input devices 640 are often connected to processing unit 602 through a corresponding port interface 642 that is coupled to the system bus, but may be connected by other interfaces, such as a parallel port, serial port, or universal serial bus (USB). One or more output devices 644 (e.g., display, a monitor, printer, projector, or other type of displaying device) is also connected to system bus 606 via interface 646, such as a video adapter.

Computer system 600 may operate in a networked environment using logical connections to one or more remote computers, such as remote computer 648. Remote computer 648 may be a workstation, computer system, router, peer device, or other common network node, and typically includes many or all the elements described relative to computer system 600. The logical connections, schematically indicated at 650, can include a local area network (LAN) and/or a wide area network (WAN), or a combination of these, and can be in a cloud-type architecture, for example configured as private clouds, public clouds, hybrid clouds, and multi-clouds. When used in a LAN networking environment, computer system 600 can be connected to the local network through a network interface or adapter 652. When used in a WAN networking environment, computer system 600 can include a modem, or can be connected to a communications server on the LAN. The modem, which may be internal or external, can be connected to system bus 606 via an appropriate port interface. In a networked environment, application programs 634 or program data 638 depicted relative to computer system 600, or portions thereof, may be stored in a remote memory storage device 654.

Although this disclosure includes a detailed description on a computing platform and/or computer, implementation of the teachings recited herein are not limited to only such computing platforms. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models (e.g., software as a service (Saas, platform as a service (PaaS), and/or infrastructure as a service (IaaS)) and at least four deployment models (e.g., private cloud, community cloud, public cloud, and/or hybrid cloud). A cloud computing environment can be service oriented with a focus on statelessness, low coupling, modularity, and semantic interoperability.

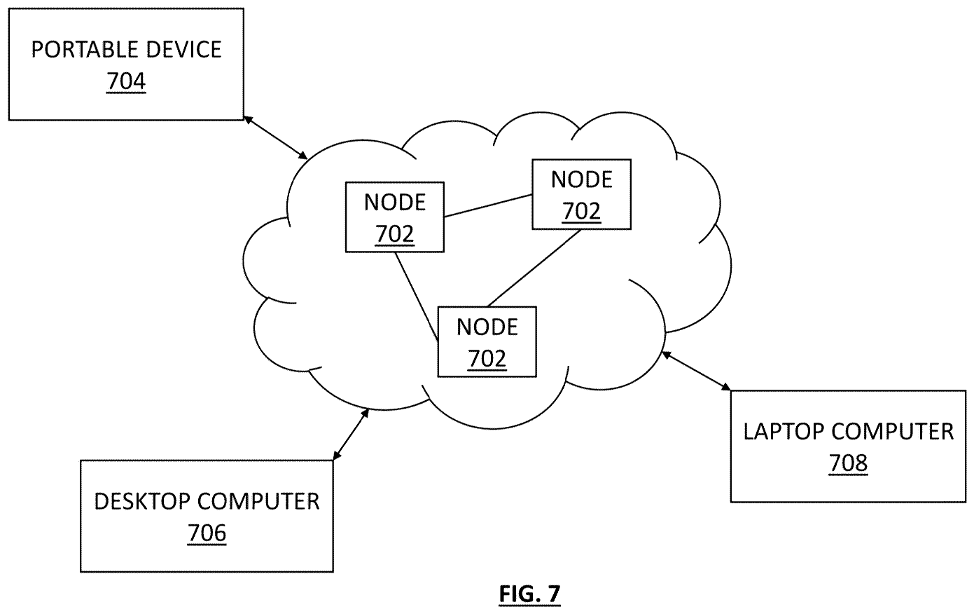

FIG. 7 is an example of a cloud computing environment 700 that can be used for implementing one or more modules and/or systems in accordance with one or more examples, as disclosed herein. Thus, reference can be made to one or more examples of FIGS. 1-6 in the example of FIG. 7. As shown, cloud computing environment 700 can include one or more cloud computing nodes 702 with which local computing devices used by cloud consumers (or users), such as, for example, personal digital assistant (PDA), cellular, or portable device 704, a desktop computer 706, and/or a laptop computer 708, may communicate. The computing nodes 702 can communicate with one another. In some examples, the computing nodes 702 can be grouped (not shown) physically or virtually, in one or more networks, such as Private, Community, Public, or Hybrid clouds, or a combination thereof. This allows the cloud computing environment 700 to offer infrastructure, platforms and/or software as services for which a cloud consumer does not need to maintain resources on a local computing device. The devices 704-708, as shown in FIG. 7, are intended to be illustrative and that computing nodes 702 and cloud computing environment 700 can communicate with any type of computerized device over any type of network and/or network addressable connection (e.g., using a web browser), In some examples, the one or more computing nodes 702 are used for implementing one or more examples disclosed herein relating to root-source identification. Thus, in some examples, the one or more computing nodes can be used to implement modules, platforms, and/or systems, as disclosed herein.

In some examples, the cloud computing environment 700 can provide one or more functional abstraction layers. It is to be understood that the cloud computing environment 700 need not provide all of the one or more functional abstraction layers (and corresponding functions and/or components), as disclosed herein. For example, the cloud computing environment 700 can provide a hardware and software layer that can include hardware and software components. Examples of hardware components include: mainframes; RISC (Reduced Instruction Set Computer) architecture based servers; servers; blade servers; storage devices; and networks and networking components. In some embodiments, software components include network application server software and database software.

In some examples, the cloud computing environment 700 can provide a virtualization layer that provides an abstraction layer from which the following examples of virtual entities may be provided: virtual servers; virtual storage; virtual networks, including virtual private networks; virtual applications and operating systems; and virtual clients. In some examples, the cloud computing environment 700 can provide a management layer that can provide the functions described below. For example, the management layer can provide resource provisioning that can provide dynamic procurement of computing resources and other resources that are utilized to perform tasks within the cloud computing environment. The management layer can also provide metering and pricing to provide cost tracking as resources are utilized within the cloud computing environment 700, and billing or invoicing for consumption of these resources. In one example, these resources may include application software licenses. Security provides identity verification for cloud consumers and tasks, as well as protection for data and other resources. The management layer can also provide a user portal that provides access to the cloud computing environment 700 for consumers and system administrators. The management layer can also provide service level management, which can provide cloud computing resource allocation and management such that required service levels are met. Service Level Agreement (SLA) planning and fulfillment can also be provided to provide pre-arrangement for, and procurement of, cloud computing resources for which a future requirement is anticipated in accordance with an SLA.

In some examples, the cloud computing environment 700 can provide a workloads layer that provides examples of functionality for which the cloud computing environment 700 may be utilized. Examples of workloads and functions which may be provided from this layer include: mapping and navigation; software development and lifecycle management; virtual classroom education delivery; data analytics processing; and transaction processing. Various embodiments of the present disclosure can utilize the cloud computing environment 700.

The present disclosure is also directed to the following exemplary embodiments, which can be practiced in any combination thereof:

A. A computer-implemented method for optimizing shallow subsurface imaging comprising:
applying super-virtual interferometric redatuming (SVIR) to seismic wave data; and
applying wave-equation travel-time inversion (WTI) to the redatumed seismic wave data.

B. A machine-readable storage medium having stored thereon a computer program for optimizing shallow subsurface imaging, the computer program comprising a routine of set instructions for causing the machine to perform the steps of:
applying super-virtual interferometric redatuming (SVIR) to seismic wave data; and
applying wave-equation travel-time inversion (WTI) to the redatumed seismic wave data.

Each of embodiments A and B may have one or more of the following additional elements in any combination: Element 1: applying SVIR comprises performing cross-correlation redatuming and summation followed by a convolution-type redatuming and summation to restore original acquisition geometry. Element 2: WTI comprises using first break picks from newly picked arrivals. Element 3: WTI comprises using improved initial velocity model from reconstructed virtual gathers. Element 4: near offset picks are preserved from the seismic wave data. Element 5: far receivers are re-picked from newly reconstructed data. Element 6: WTI is performed in accordance with the equation:

$${f}_{Δ τ} = \int d t \frac{p ( {x}_{r} , t + Δτ ; {x}_{s} )}{{A}_{d} ( {x}_{r} ; {x}_{s} )} p ( {x}_{r} , t ; {x}_{s} )$$

where A_{d}(xᵣ; xₛ) is maximum amplitude of p(xᵣ, t+Δτ; xₛ), Δτ is travel-times residual between synthetic and original seismograms to compute for the Frechet derivative. Element 7: SVIR is performed in accordance with the equation:

$${G}^{v} ( {r}_{2} , {r}_{1} ) = {\sum }_{s} G ( {r}_{2} , s ) {G}^{*} ( {r}_{1} , s )$$

wherein the recorded Green's functions G(r₂,s) and G(r₁,s) from shot s to receivers r₁ and r₂ is a result of cross correlation and the summation of virtual data G^{v}(r₂,r₁).

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts or carry out combinations of special purpose hardware and computer instructions.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The term “based on” means “based at least in part on.” The terms “about” and “approximately” can be used to include any numerical value that can vary without changing the basic function of that value. When used with a range, “about” and “approximately” also disclose the range defined by the absolute values of the two endpoints, e.g. “about 2 to about 4” also discloses the range “from 2 to 4.” Generally, the terms “about” and “approximately” may refer to plus or minus 5-10% of the indicated number.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A computer-implemented method for optimizing shallow subsurface imaging comprising:
applying super-virtual interferometric redatuming (SVIR) to seismic wave data; and
applying wave-equation travel-time inversion (WTI) to the redatumed seismic wave data.

2. The method of claim 1, wherein applying SVIR comprises performing cross-correlation redatuming and summation followed by a convolution-type redatuming and summation to restore original acquisition geometry.

3. The method of claim 2, wherein WTI comprises using first break picks from newly picked arrivals.

4. The method of claim 2, wherein WTI comprises using improved initial velocity model from reconstructed virtual gathers.

5. The method of claim 2, wherein near offset picks are preserved from the seismic wave data.

6. The method of claim 2, wherein far receivers are re-picked from newly reconstructed data.

7. The method of claim 1, wherein WTI is performed in accordance with the equation:
$${f}_{Δ τ} = \int d t \frac{p ( {x}_{r} , t + Δτ ; {x}_{s} )}{{A}_{d} ( {x}_{r} ; {x}_{s} )} p ( {x}_{r} , t ; {x}_{s} )$$
where A_{d}(xᵣ; xₛ) is maximum amplitude of p(xᵣ, t+Δτ; xₛ), Δτ is travel-times residual between synthetic and original seismograms to compute for the Frechet derivative.

8. The method of claim 1, wherein SVIR is performed in accordance with the equation:
$${G}^{v} ( {r}_{2} , {r}_{1} ) = {\sum }_{s} G ( {r}_{2} , s ) {G}^{*} ( {r}_{1} , s )$$
wherein the recorded Green's functions G(r₂,s) and G(r₁,s) from shot s to receivers r₁ and r₂ is a result of cross correlation and the summation of virtual data G^{v}(r₂,r₁).

9. A machine-readable storage medium having stored thereon a computer program for optimizing shallow subsurface imaging, the computer program comprising a routine of set instructions for causing the machine to perform the steps of:
applying super-virtual interferometric redatuming (SVIR) to seismic wave data; and
applying wave-equation travel-time inversion (WTI) to the redatumed seismic wave data.

10. The machine-readable storage medium of claim 9, wherein applying SVIR comprises performing cross-correlation redatuming and summation followed by a convolution-type redatuming and summation to restore original acquisition geometry.

11. The machine-readable storage medium of claim 9, wherein WTI comprises using first break picks from newly picked arrivals.

12. The machine-readable storage medium of claim 9, wherein WTI comprises using improved initial velocity model from reconstructed virtual gathers.

13. The machine-readable storage medium of claim 9, wherein near offset picks are preserved from the seismic wave data.

14. The machine-readable storage medium of claim 9, wherein far receivers are re-picked from newly reconstructed data.

15. The machine-readable storage medium of claim 9, wherein WTI is performed in accordance with the equation:
$${f}_{Δ τ} = \int d t \frac{p ( {x}_{r} , t + Δτ ; {x}_{s} )}{{A}_{d} ( {x}_{r} ; {x}_{s} )} p ( {x}_{r} , t ; {x}_{s} )$$
where A_{d}(xᵣ; xₛ) is maximum amplitude of p(xᵣ, t+Δτ; xₛ), Δτ is travel-times residual between synthetic and original seismograms to compute for the Frechet derivative.

16. The machine-readable storage medium of claim 9, wherein SVIR is performed in accordance with the equation:
$${G}^{v} ( {r}_{2} , {r}_{1} ) = {\sum }_{s} G ( {r}_{2} , s ) {G}^{*} ( {r}_{1} , s )$$
wherein the recorded Green's functions G(r₂,s) and G(r₁,s) from shot s to receivers r₁ and r₂ is a result of cross correlation and the summation of virtual data G^{v}(r₂,r₁).
